(19) United States
(12) Patent Application Publication
(10) Pub. No.: US 2003/0090970 A1
(43) Pub. Date: May 15, 2003

(54) Optical head and optical disk device

(75) Inventors: Katsuya Watanabe, Nara-shi (JP); Shin-ichi Yamada, Katano-shi (JP); Kenji Fujiune, Takatsuki-shi (JP); Mitsurou Moriya, Ikoma-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/293,590

(22) Filed: Nov. 12, 2002

(30) Foreign Application Priority Data
Nov. 12, 2001 (JP) 2001-345586
Sep. 26, 2002 (JP) 2002-281867

(51) Int. Cl. G11B 7/095

(52) U.S. Cl. 369/44.37

(57) ABSTRACT

An optical head includes a semiconductor laser, a diffraction grating, an objective lens and a photodetector. The optical head is configured so that a first sub-beam is converged in a position preceding a position of a main beam along a scanning direction of the optical head with respect to an information medium, and a second sub-beam is converged in a position succeeding the position of the main beam along the scanning direction of the optical head with respect to the information medium. The diffraction grating divides light beams into the main beam, the first sub-beam and the second sub-beam so that the first sub-beam preceding the main beam is converged at a more outer circumferential side of the information medium than the main beam is, and the second-sub beam succeeding the main beam is converged at a more inner circumferential side of the information medium than the main beam is.

### BACKGROUND OF THE INVENTION

1. Field of the Invention

The present invention relates to an optical head for radiating light beams onto information tracks formed spirally on a rotatable information medium so that information can be reproduced from and/or recorded on the information tracks, and an optical disk apparatus including the same.

2. Related Background Art

An optical head and an optical disk apparatus according to a conventional technique are disclosed in JP11(1999)-296875 A (p. 7-8, FIG. 1). For the purpose of increasing the density of information to be recorded on an optical disk, recording is performed using an objective lens with the highest possible NA at the shortest possible wavelength. However, when a light beam is converged on information tracks with a narrow track pitch, there is a limit to the degree to which a spot diameter of the light beam can be reduced. With this as a background, in order to increase the recording density and capacity of an optical disk, a method has been proposed in which information recorded on information tracks is reproduced using a light beam having a spot diameter that is somewhat larger than the width of the information track. In the method, the influence of intersymbol interference and crosstalk can be reduced by PRML and the use of a nonlinear equalizer. In such an optical disk with a narrow track pitch, an allowable error of tracking control in tracking control is highly limited.

FIG. 12 is a schematic diagram showing a relationship between light beams radiated from a conventional optical head onto an optical disk and information tracks formed on the optical disk. Information tracks 7 on which information is recorded are formed spirally on an optical disk 6. The information tracks 7 are made up of grooves formed on a surface of the optical disk 6. On the information tracks 7 formed spirally on the optical disk 6, information is recorded starting from an inner circumferential side toward an outer circumferential side of the optical disk 6. On the information tracks 7 formed spirally on the optical disk 6, a recorded region R5 on which information has been prerecorded is arranged on an inner circumferential side in the information tracks 7, and an unrecorded region R6 on which no information has been recorded yet is arranged on an outer circumferential side in the information tracks 7. The recorded region R5 is shown to be diagonally shaded in the figure.

With the optical head provided in a conventional optical disk apparatus, light beams, which are emitted from a light source and divided into a main beam M, a first sub-beam S1 and a second sub-beam S2 by a diffraction grating, are converged on the information tracks 7 by an objective lens, so that the information can be reproduced from the information tracks 7 formed spirally on the rotatable optical disk 6. The light source is formed of, for example, a semiconductor laser.

In an example shown in FIG. 12, the optical head radiates the main beam M, the first sub-beam S1 and the second sub-beam S2 onto a boundary between the recorded region R5 and the unrecorded region R6 arranged on the information tracks 7. The main beam M is converged on the boundary between the recorded region R5 and the unrecorded region R6 on the information tracks 7. The first sub-beam S1 is converged in a position preceding a position of the main beam M along a scanning direction of the optical head with respect to the optical disk 6. The second sub-beam S2 is converged in a position succeeding the position of the main beam M along the scanning direction of the optical head with respect to the optical disk 6. The first sub-beam S1 preceding the main beam M is converged at a more inner circumferential side of the optical disk 6 than the main beam M is. The second sub-beam S2 succeeding the main beam M is converged at a more outer circumferential side of the optical disk 6 than the main beam M is.

A photodetector provided in the optical head detects a main beam signal, a first sub-beam signal and a second sub-beam signal based respectively on the main beam M, the first sub-beam S1 and the second sub-beam S2 that have been reflected from the information tracks. The optical disk apparatus generates a tracking error signal based on the main beam signal, the first sub-beam signal and the second sub-beam signal that have been detected by the photodetector according to a differential push-pull method. The tracking error signal is generated so that a lens shift, which is a shift caused between a center of the objective lens and a center of the photodetector because of decentering of the optical disk 6, can be cancelled. Tracking control is performed with respect to the optical head based on the tracking error signal so that the optical head follows the information tracks 7 formed on the optical disk 6.

Tracking control by the differential push-pull method as described above can reduce a beam spot shift from a track center ascribable to a lens shift.

However, in the above-mentioned configuration according to the conventional technique, when the main beam M is converged on the boundary between the recorded region R5 and the unrecorded region R6 that are arranged on the information tracks 7 so that information can be recorded on the information tracks 7, the first sub-beam S1 preceding the main beam M overlaps the recorded region R5 in a region R91 of the first sub-beam S1 on the inner circumferential side, while it overlaps the unrecorded region R6 in a region R92 thereof on the outer circumferential side. This results in variations in the quantity of light of the first sub-beam S1 reflected from the optical disk 6 to be incident on the photodetector, thereby causing the first sub-beam S1 to vary in light quantity. Similarly, the second sub-beam S2 succeeding the main beam M overlaps the recorded region R5 in a region R93 of the second sub-beam S2 on the inner circumferential side, while it overlaps the unrecorded region R6 in a region R94 thereof on the outer circumferential side. This results in variations in the quantity of light the second sub-beam S2 reflected from the optical disk 6 to be incident on the photodetector, thereby causing the second sub-beam S2 to vary in light quantity.

Accordingly, the first sub-beam signal and the second sub-beam signal that are detected by the photodetector based respectively on the first sub-beam S1 and the second sub-beam S2 become unbalanced. This causes an offset in a tracking error signal generated based on the first sub-beam signal and the second sub-beam signal. As a result, a beam spot shift from a track center occurs, so that signals recorded on and/or reproduced from the optical disk may be deteriorated in quality, which has been disadvantageous.

When coma aberration is caused in a beam spot resulting from converging of a sub-beam, a zero-crossing position of a push-pull signal based on a sub-beam signal shifts from a center line of each of the grooves constituting the information tracks. Further, the shift amount varies because of the displacement of the objective lens. Thus, in a tracking control method employing differential push-pull as described above, a beam spot shift from a track center occurs even when tracking control is performed so that differential push-pull becomes zero. This may result in deterioration in the quality of signals recorded on and/or reproduced from the optical disk, which has been disadvantageous.

In order to solve the above-mentioned problems, it is an object of the present invention to provide an optical head and an optical disk apparatus that can achieve an excellent quality of signals recorded on and/or reproduced from an optical disk.

### SUMMARY OF THE INVENTION

With the foregoing in mind, an optical head according to the present invention is an optical head for radiating light beams onto information tracks formed spirally on a rotatable information medium so that information can be recorded on the information tracks. The optical head includes a light source that emits the light beams, a diffraction grating that diffracts the light beams emitted from the light source so that the light beams are divided into a main beam, a first sub-beam and a second sub-beam, an objective lens for converging the main beam, the first sub-beam and the second sub-beam resulting from diffraction by the diffraction grating, respectively, on the information tracks formed on the information medium, and a photodetector that detects a main beam signal, a first sub-beam signal and a second sub-beam signal, respectively, based on the main beam, the first sub-beam and the second sub-beam that have been reflected respectively from the information tracks formed on the information medium. The first sub-beam is set so as to be converged in a position preceding a position of the main beam along a scanning direction of the optical head with respect to the information medium, and the second sub-beam is set so as to be converged in a position succeeding the position of the main beam along the scanning direction of the optical head with respect to the information medium. The diffraction grating divides the light beams into the main beam, the first sub-beam and the second sub-beam so that the first sub-beam preceding the main beam is converged at a more outer circumferential side of the information medium than the main beam is, and the second sub-beam succeeding the main beam is converged at a more inner circumferential side of the information medium than the main beam is.

An optical disk apparatus according to the present invention includes the optical head according to the present invention, a motor for rotating the information medium, a differential push-pull signal generator that generates a differential push-pull signal based on the main beam signal, the first sub-beam signal and the second sub-beam signal that have been detected by the photodetector provided in the optical head, and a rotation direction setting unit that sets a rotation direction of the motor so that the first sub-beam is converged so as to precede the main beam along the scanning direction of the optical head with respect to the information medium, and the second sub-beam is converged so as to succeed the main beam along the scanning direction of the optical head with respect to the information medium, according to the differential push-pull signal generated by the differential push-pull signal generator.

An optical disk apparatus of another configuration according to the present invention includes an optical head for radiating light beams onto information tracks so that information can be recorded on and/or reproduced from the information tracks. The optical head includes a light source that emits the light beams, a diffraction grating that diffracts the light beams emitted from the light source so that the light beams are divided into a main beam, a first sub-beam and a second sub-beam, an objective lens for converging the main beam, the first sub-beam and the second sub-beam resulting from diffraction by the diffraction grating, respectively, on the information tracks formed on the information medium, and a photodetector that detects a main beam signal, a first sub-beam signal and a second sub-beam signal, respectively, based on the main beam, the first sub-beam and the second sub-beam that have been reflected respectively from the information tracks formed on the information medium. The optical disk apparatus further includes a differential push-pull signal generator that generates a main beam push-pull signal based on the main beam signal detected by the photodetector provided in the optical head, generates a sub-beam push-pull signal based on the first and second sub-beam signals detected by the photodetector, and generates a correction differential push-pull signal based on the main beam signal, the first and second sub-beam signals and a predetermined correction coefficient β, and a correction coefficient adjusting unit that adjusts the predetermined correction coefficient β used for generating the correction differential push-pull signal by the differential push-pull signal generator so that the main beam push-pull signal generated by the differential push-pull signal generator becomes equal to the sub-beam push-pull signal in level at a time when the main beam push-pull signal attains a central amplitude level for the main beam push-pull signal.

An optical disk apparatus of still another configuration according to the present invention includes an optical head for radiating light beams onto information tracks so that information can be recorded on and/or reproduced from the information tracks. The optical head includes a light source that emits the light beams, a diffraction grating that diffracts the light beams emitted from the light source so that the light beams are divided into a main beam, a first sub-beam and a second sub-beam, an objective lens for converging the main beam, the first sub-beam and the second sub-beam resulting from diffraction by the diffraction grating, respectively, on the information tracks formed on an information medium, and a photodetector that detects a main beam signal, a first sub-beam signal and a second sub-beam signal, respectively, based on the main beam, the first sub-beam and the second sub-beam that have been reflected respectively from the information tracks formed on the information medium. The optical disk apparatus further includes a differential push-pull signal generator that generates a main beam push-pull signal based on the main beam signal detected by the photodetector provided in the optical head, generates a sub-beam push-pull signal based on the first and second sub-beam signals detected by the photodetector, and generates a correction differential push-pull signal based on the main beam signal, the first and second sub-beam signals and a predetermined correction coefficient β, a tracking driving circuit provided so as to drive the objective lens provided in the optical head along a radial direction of the information medium on which the information tracks are formed, based on the correction differential push-pull signal, and a correction coefficient adjusting unit that adjusts the predetermined correction coefficient β used for generating the correction differential push-pull signal by the differential push-pull signal generator so that a level of the main beam push-pull signal in a state where tracking control is operated substantially corresponds with a central amplitude level for the main beam push-pull signal in a state where the tracking control is not operated.

An optical disk apparatus of still another configuration according to the present invention includes an optical head for radiating light beams onto information tracks so that information can be recorded on and/or reproduced from the information tracks. The optical head includes a light source that emits the light beams, a diffraction grating that diffracts the light beams emitted from the light source so that the light beams are divided into a main beam, a first sub-beam and a second sub-beam, an objective lens for converging the main beam, the first sub-beam and the second sub-beam resulting from diffraction by the diffraction grating, repectively, on the information tracks formed on the information medium, and a photodetector that detects a main beam signal, a first sub-beam signal and a second sub-beam signal, respectively, based on the main beam, the first sub-beam and the second sub-beam that have been reflected respectively from the information tracks formed on the information medium. The optical disk apparatus further includes a differential push-pull signal generator that generates a main beam push-pull signal based on the main beam signal detected by the photodetector provided in the optical head, generates a sub-beam push-pull signal based on the first and second sub-beam signals detected by the photodetector, and generates an offset differential push-pull signal based on the main beam signal, the first and second sub-beam signals and a predetermined offset amount, and an offset amount adjusting unit that adjusts the predetermined offset amount used for generating the offset differential push-pull signal by the differential push-pull signal generator so that the main beam push-pull signal generated by the differential push-pull signal generator becomes equal to the sub-beam push-pull signal in level at a time when the main beam push-pull signal attains a central amplitude level for the main beam push-pull signal.

### BRIEF DESCRIPTION OF THE DRAWINGS

FIG. 1 is a block diagram showing an optical disk apparatus according to Embodiment 1.

FIG. 2 is a diagram showing the configuration of an optical head provided in the optical disk apparatus according to Embodiment 1.

FIG. 3 is a schematic diagram showing the relationship between light beams radiated from the optical head according to Embodiment 1 onto an information medium and information tracks formed on the information medium.

FIG. 4 is a front view for showing the configuration of a photodetector provided in the optical head according to Embodiment 1.

FIG. 5 is a block diagram showing the configuration of an optical disk apparatus according to Embodiment 2.

FIG. 6 is a wave form chart for explaining the operation of the optical disk apparatus according to Embodiment 2.

FIG. 7 is a graph showing the relationship between a displacement amount of an objective lens and a phase shift in the optical disk apparatus according to Embodiment 2.

FIG. 8 is another wave form chart for explaining the operation of the optical disk apparatus according to Embodiment 2.

FIG. 9 is a wave form chart for explaining another operation of the optical disk apparatus according to Embodiment 2.

FIG. 10 is a wave form chart for explaining still another operation of the optical disk apparatus according to Embodiment 2.

FIG. 11 is a wave form chart for explaining still another operation of the optical disk apparatus according to Embodiment 2.

FIG. 12 is a schematic diagram showing the relationship between light beams radiated from a conventional optical head onto an information medium and information tracks formed on the information medium.

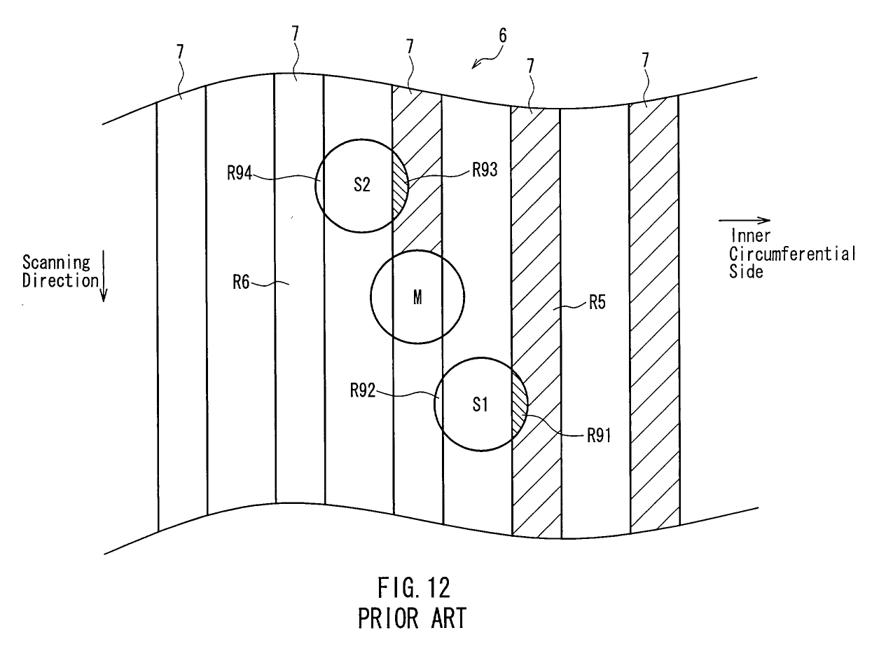

### DETAILED DESCRIPTION OF THE INVENTION

In an optical head according to this embodiment, a first sub-beam is set so as to be converged in a position preceding a position of a main beam along a scanning direction of the optical head with respect to an information medium. Further, a second sub-beam is set so as to be converged in a position succeeding the position of the main beam along the scanning direction of the optical head with respect to the information medium. A diffraction grating divides light beams into the main beam, the first sub-beam and the second sub-beam so that the first sub-beam preceding the main beam is converged at a more outer circumferential side of the information medium than the main beam is, and the second sub-beam succeeding the main beam is converged at a more inner circumferential side of the information medium than the main beam is.

According to this configuration, the preceding first sub-beam can be converged so as to bridge between an unrecorded region of information tracks and another unrecorded region of the information tracks arranged adjacently to the unrecorded region of the information tracks on an outer circumferential side. Further, the succeeding second sub-beam can be converged so as to bridge between a recorded region of the information tracks and another recorded region of the information tracks arranged adjacently to the recorded region of the information tracks on an inner circumferential side. Thus, a first sub-beam signal detected based on the first sub-beam and a second sub-beam signal detected based on the second sub-beam become well balanced, so that an offset does not occur in a differential push-pull signal generated based on the first sub-beam signal and the second sub-beam signal. As a result, recording/reproduction signals can be improved in quality.

Preferably, the diffraction grating divides the light beams into the main beam, the first sub-beam and the second sub-beam so that the first sub-beam is converged at a more outer circumferential side of the information medium than the information track by about ½ of a track pitch of the spirally formed information tracks, and the second sub-beam is converged at a more inner circumferential side of the information medium than the information track by about ½ of the track pitch.

Preferably, the first sub-beam is converged so as to bridge between a first region of the information tracks and a second region of the information tracks arranged adjacently to the first region of the information tracks on an outer circumferential side, and the second sub-beam is converged so as to bridge between a third region of the information tracks and a fourth region of the information tracks arranged adjacently to the third region of the information tracks on an inner circumferential side.

Preferably, the information tracks are made up of grooves formed on a surface of the information medium.

Preferably, on the information tracks formed spirally on the information medium, the information is recorded starting from an inner circumferential side toward an outer circumferential side.

Preferably, on the information tracks formed spirally on the information medium, a recorded region on which the information has been prerecorded is arranged on an inner circumferential side of the information tracks, and an unrecorded region on which the information has not been recorded yet is arranged on an outer circumferential side of the information tracks.

Preferably, the optical head starts recording of the main beam, the first sub-beam and the second sub-beam on the information tracks from a boundary between the recorded region and the unrecorded region arranged on the information tracks.

Preferably, the main beam is a Oth-order diffracted light beam that originates in the light beams, the first sub-beam is one of a +1st-order diffracted light beam and a −1st-order diffracted light beam that originate in the light beams, and the second sub-beam is the other of the +1st-order diffracted light beam and the −1st-order diffracted light beam that originate in the light beams.

Preferably, a beam splitter further is provided between the diffraction grating and the objective lens so that the main beam, the first sub-beam and the second sub-beam that have been reflected from the information tracks can be led to the photodetector.

In the optical disk apparatus according to this embodiment, a rotation direction of a motor is set so that a first sub-beam is converged so as to precede a main beam along a scanning direction of an optical head with respect to an information medium, and a second sub-beam is converged so as to succeed the main beam along the scanning direction of the optical head with respect to the information medium, according to a differential push-pull signal generated by a differential push-pull signal generator.

According to this configuration, the preceding first sub-beam can be converged so as to bridge between an unrecorded region of the information tracks and another unrecorded region of the information tracks arranged adjacently to the unrecorded region of the information tracks on an outer circumferential side. Further, the succeeding second sub-beam can be converged so as to bridge between a recorded region of the information tracks and another recorded region of the information tracks arranged adjacently to the recorded region of the information tracks on an inner circumferential side. Thus, a first sub-beam signal detected based on the first sub-beam and a second sub-beam signal detected based on the second sub-beam become well balanced, so that an offset does not occur in the differential push-pull signal generated based on the first sub-beam signal and the second sub-beam signal. As a result, recording/reproduction signals can be improved in quality.

Preferably, a tracking driving circuit further is provided that drives the optical head along a radial direction of the information medium so that the main beam radiated from the optical head follows the information tracks, based on the differential push-pull signal generated by the differential push-pull signal generator.

In an optical disk apparatus of another configuration according to this embodiment, a predetermined correction coefficient β used for generating a correction differential push-pull signal by a differential push-pull signal generator is adjusted so that a main beam push-pull signal generated by the differential push-pull signal generator becomes equal to a sub-beam push-pull signal in level at a time when the main beam push-pull signal attains a central amplitude level for the main beam push-pull signal. Thus, excellent tracking control without the occurrence of a beam spot shift from a track center can be realized.

Preferably, the photodetector includes a main beam detecting unit that detects the main beam signal based on the main beam, a first sub-beam detecting unit that detects the first sub-beam signal based on the first sub-beam, and a second sub-beam detecting unit that detects the second sub-beam signal based on the second sub-beam.

Preferably, each of the main beam detecting unit, the first sub-beam detecting unit and the second sub-beam detecting unit is divided into two regions along a direction corresponding to a circumferential direction of the spirally formed information tracks.

Preferably, a conveying unit further is provided that conveys the optical head along a radial direction of the information medium on which the information tracks are formed, based on the correction differential push-pull signal that the differential push-pull signal generator generates according to the correction coefficient β adjusted by the correction coefficient adjusting unit.

Preferably, a tracking driving circuit further is provided that drives the objective lens provided in the optical head along the radial direction of the information medium on which the information tracks are formed, based on the correction differential push-pull signal that the differential push-pull signal generator generates according to the correction coefficient β adjusted by the correction coefficient adjusting unit.

Preferably, an objective lens displacement signal generating circuit further is provided that generates an objective lens displacement signal indicating a displacement amount of the objective lens driven by the tracking driving circuit, based on the main beam signal, the first sub-beam signal and the second sub-beam signal that have been detected by the photodetector.

Preferably, the correction coefficient adjusting unit stores in a predetermined memory the objective lens displacement signal generated by the objective lens displacement signal generating circuit and the predetermined correction coefficient β adjusted so that the main beam push-pull signal becomes equal to the sub-beam push-pull signal in level at a time when the main beam push-pull signal attains a central amplitude level for the main beam push-pull signal, while varying a set value to be set for the tracking driving circuit where tracking control by the tracking driving circuit is in a non-operational state.

In an optical disk apparatus of still another configuration according to this embodiment, a predetermined correction coefficient β used for generating a correction differential push-pull signal by a differential push-pull signal generator is adjusted so that a maximum amplitude BV at a positive side of a main beam push-pull signal is substantially equal to a maximum amplitude SV at a negative side of the main beam push-pull signal, during a time period in which a tracking driving circuit drives an objective lens toward an outer circumferential direction so that a beam spot of a main beam radiated from an optical head onto an information medium moves to an adjacent information track on an outer circumferential side.

According to this configuration, the main beam push-pull signal zero-crosses at a timing corresponding to a midpoint between adjacent information tracks. As a result, a beam spot shift from a track center in the main beam push-pull signal can be eliminated.

Preferably, the correction coefficient adjusting unit measures the maximum amplitude BV at the positive side of the main beam push-pull signal and the maximum amplitude SV at the negative side of the main beam push-pull signal with reference to a zero level of the main beam push-pull signal during a period other than a jumping period in which the light beams are allowed to shift along the radial direction, and adjusts the predetermined correction coefficient β so that the maximum amplitude BV at the positive side is substantially equal to the maximum amplitude SV at the negative side.

Preferably, the correction coefficient adjusting unit measures a maximum amplitude BV at a positive side of the main beam push-pull signal and a maximum amplitude SV at a negative side of the main beam push-pull signal with reference to a level of the main beam push-pull signal in a state where the tracking control is operated during a period in which the tracking driving circuit drives the objective lens toward one of an outer circumferential side and an inner circumferential side so that a beam spot of the main beam radiated from the optical head onto the information medium moves to an adjacent information track on the one of the outer circumferential side and the inner circumferential side, and adjusts the predetermined correction coefficient β so that the maximum amplitude BV at the positive side is substantially equal to the maximum amplitude SV at the negative side.

Preferably, the tracking driving circuit performs the tracking control by setting the correction coefficient β to be substantially zero during a predetermined period after starting the tracking control.

Preferably, the correction coefficient adjusting unit limits a range of values of the correction coefficient β to be adjusted.

In an optical disk apparatus of still another configuration according to this embodiment, a predetermined offset amount used for generating an offset differential push-pull signal by a differential push-pull signal generator is adjusted so that a main beam push-pull signal becomes equal to a sub-beam push-pull signal in level at a time when the main beam push-pull signal attains a central amplitude level for the main beam push-pull signal.

According to this configuration, excellent tracking control without the occurrence of a beam spot shift from a track center can be realized.

Hereinafter, the present invention will be described by way of embodiments with reference to the appended drawings.

(Embodiment 1)

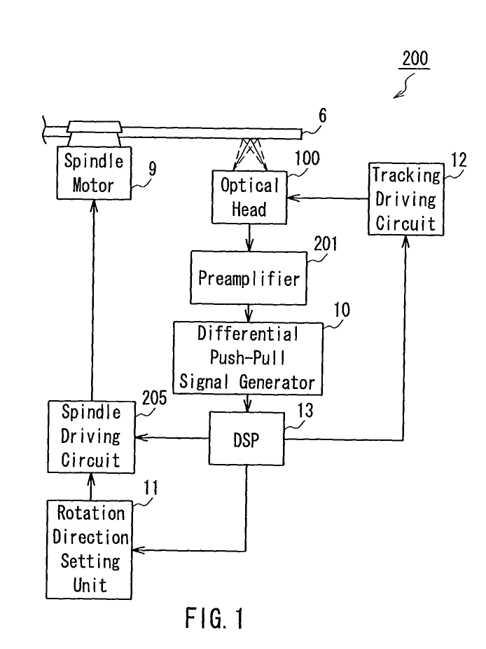

FIG. 1 is a block diagram showing a configuration of an optical disk apparatus 200 according to Embodiment 1. The optical disk apparatus 200 includes an optical head 100.

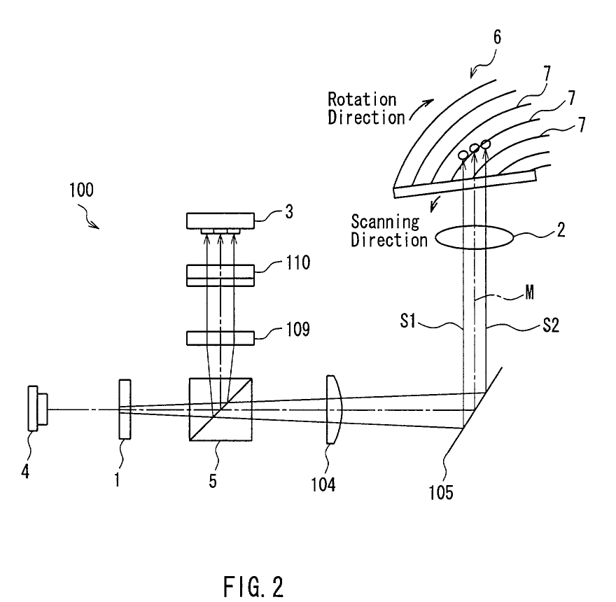

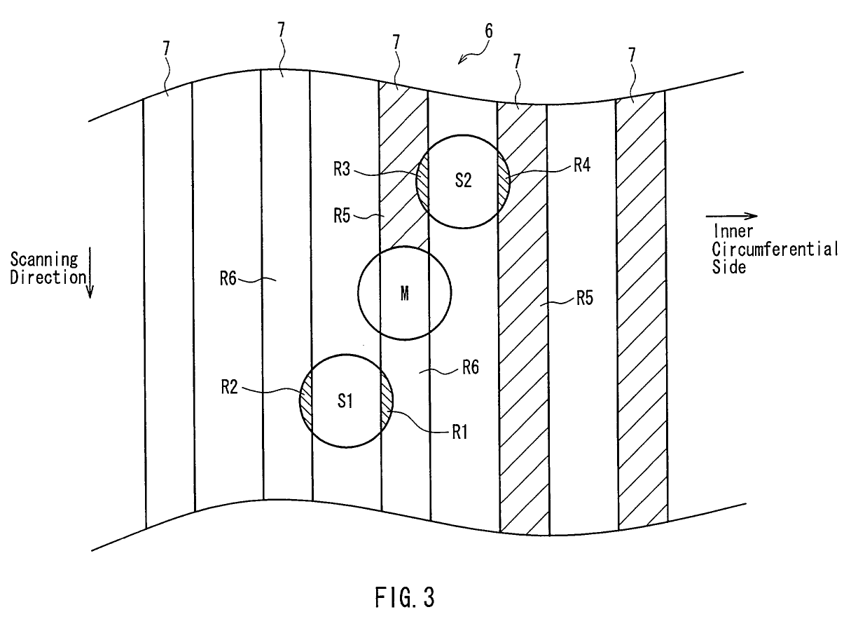

FIG. 2 is a diagram showing a configuration of the optical head 100. FIG. 3 is a schematic diagram showing a relationship between light beams radiated from the optical head 100 onto an optical disk 6 and information tracks 7 formed on the optical disk 6. The optical head 100 radiates the light beams onto the optical disk 6 so that information can be recorded on the information tracks 7 formed spirally on the optical disk 6 driven to rotate by a spindle motor 9. Alight source is provided in the optical head 100. The light source is formed of, for example, a semiconductor laser 4. The semiconductor laser 4 emits the light beams to a diffraction grating 1. The diffraction grating 1 diffracts the light beam emitted from the semiconductor laser 4 so that the light beams are divided into a main beam M, a first sub-beam S1 and a second sub-beam S2. The main beam M is a 0th-order diffracted light beam originating in the light beams, the first sub-beam S1 is a +1st-order diffracted light beam originating in the light beams, and the second sub-beam S2 is a −1st-order diffracted light beam originating in the light beams.

The main beam M, the first sub-beam S1 and the second sub-beam S2 that result from diffraction by the diffraction grating 1 are transmitted through a beam splitter 5 to be condensed by a condensing lens 104. Then, these beams are reflected from a reflecting mirror 105 to be incident on an objective lens 2. The objective lens 2 converges the main beam M, the first sub-beam S1 and the second sub-beam S2 that have been incident on the objective lens 2 on the information tracks 7 formed on the optical disk 6, respectively.

As shown in FIG. 3, the information tracks 7, on which information is recorded, are formed spirally on the optical disk 6. The information tracks 7 are made up of grooves formed on a surface of the optical disk 6. The optical disk 6 is formed of, for example, a CD-R/RW, a DVD-R/-RW or the like. On the information tracks 7 formed spirally on the optical disk 6, information is recorded starting from an inner circumferential side toward an outer circumferential side of the optical disk 6. On the information tracks 7 formed spirally on the optical disk 6, a recorded region R5 on which information has been prerecorded is arranged on an inner circumferential side in the information tracks 7, and an unrecorded region R6 on which no information has been recorded yet is arranged in an outer circumferential side in the information tracks 7. The recorded region R5 is shown to be diagonally shaded in the figure. When recording additional information on such an optical disk, the information is recorded starting from a boundary between the recorded region R5 and the unrecorded region R6.

In an example shown in FIG. 3, the optical head 100 radiates the main beam M, the first sub-beam S1 and the second sub-beam S2 onto a boundary between the recorded region R5 and the unrecorded region R6 arranged on the information tracks 7. The main beam M is converged on the boundary between the recorded region R5 and the unrecorded region R6. The first sub-beam S1 is converged in a position preceding a position of the main beam M along a scanning direction of the optical head with respect to the optical disk 6. The second sub-beam S2 is converged in a position succeeding the position of the main beam M along the scanning direction of the optical head with respect to the optical disk 6. The first sub-beam S1 preceding the main beam M is converged at a more outer circumferential side of the optical disk 6 than the main beam M is by about ½ of a track pitch of the information tracks 7. The second sub-beam S2 succeeding the main beam M is converged at a more inner circumferential side of the optical disk 6 than the main beam M is by about ½ of the track pitch of the information tracks 7.

The first sub-beam S1 is converged so as to bridge between a first region R1 of the information tracks 7 and a second region R2 of the information tracks 7 arranged adjacently to the first region R1 of the information tracks 7 on an outer circumferential side. The second sub-beam S2 is converged so as to bridge between a third region R3 of the information tracks 7 and a fourth region R4 of the information tracks 7 arranged adjacently to the third region R3 of the information tracks 7 on an inner circumferential side.

As described above, the first sub-beam S1 preceding the main beam M overlaps the unrecorded region R6 on both inner and outer circumferential sides of the first sub-beam S1. The second sub-beam S2 succeeding the main beam M overlaps the recorded region R5 on both inner and outer circumferential sides of the second sub-beam S2.

The main beam M, the first sub-beam S1 and the second sub-beam S2 that have been reflected from the optical disk 6 are transmitted through the objective lens 2 to be reflected from the reflecting mirror 105. Then, these beams are transmitted through the condensing lens 104, and the respective traveling directions thereof are changed substantially perpendicularly by the beam splitter 5.

The main beam M, the first sub-beam S1 and the second sub-beam S2 whose traveling directions are changed by the beam splitter 5 are transmitted through a hologram 109 and a cylindrical lens 110 to be incident on a photodetector 3, respectively.

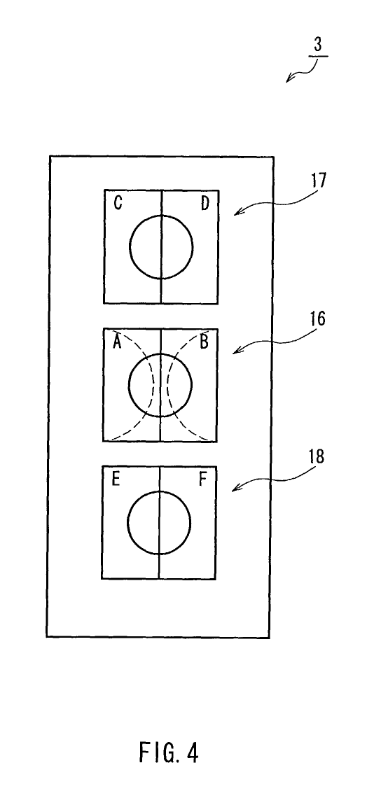

FIG. 4 is a front view for showing a configuration of the photodetector 3. The photodetector 3 includes a main beam detecting unit 16. The main beam detecting unit 16 is divided into two regions along a direction corresponding to a circumferential direction of the information tracks 7 formed spirally on the optical disk 6. The main beam detecting unit 16 detects a main beam signal A and the main beam signal B that correspond respectively to the two regions based on a main beam incident thereon and outputs them respectively to a preamplifier 201.

A first sub-beam detecting unit 17 and a second sub-beam detecting unit 18 are arranged on both sides of the main beam detecting unit 16. In the same manner as in the main beam detecting unit 16, each of the first sub-beam detecting unit 17 and the second sub-beam detecting unit 18 is divided into two regions along a direction corresponding to the circumferential direction of the information tracks 7. The first sub-beam detecting unit 17 detects a first sub-beam signal C and a first sub-beam signal D corresponding respectively to the two regions based on the first sub-beam S1 incident thereon and outputs them respectively to the preamplifier 201. The second sub-beam detecting unit 18 detects a second sub-beam signal E and a second sub-beam signal F based on the second sub-beam S2 incident thereon and outputs them respectively to the preamplifier 201.

The preamplifier 201 amplifies the main beam signal A and the main beam signal B that have been detected by the main beam detecting unit 16, the first sub-beam signal C and the first sub-beam signal D that have been detected by the first sub-beam detecting unit 17, and the second sub-beam signal E and the second sub-beam signal F that have been detected by the second sub-beam detecting unit 18, respectively, and outputs them to a differential push-pull signal generator 10.

The differential push-pull signal generator 10 generates a differential push-pull signal based on the main beam signal A, the main beam signal B, the first sub-beam signal C, the first sub-beam signal D, the second sub-beam signal E and the second sub-beam signal F that have been output from the preamplifier 201 according to the following equation (Equation 1), and outputs it to a digital signal processor (DSP) 13:

(A−B)−α×((C−D)+(E−F)) (α is a constant) (Equation 1).

The DSP 13 converts the differential push-pull signal output from the differential push-pull signal generator 10 to a digital signal, and performs a digital filter operation for phase compensation and gain compensation by way of addition/multiplication by a core processor housed in the DSP 13 with respect to the digital signal. Then, the digital signal with respect to which the digital filter operation has been performed is converted back to an analog signal by a DA converter housed in the DSP 13, and output to each of a tracking driving circuit 12, a spindle driving circuit 205 and a rotation direction setting unit 11.

The tracking driving circuit 12 performs current amplification with respect to the differential push-pull signal output from the DSP 13, and drives the optical head 100 along a radial direction of the optical disk 6 so that the main beam M radiated from the optical head 100 follows the information tracks 7. Thus, the main beam M can be controlled so as to follow a beam spot shift from a track center indicated by the differential push-pull signal.

The rotation direction setting unit 11 sets a rotation direction of the spindle motor 9 so that the first sub-beam S1 is converged so as to precede the main beam M along the scanning direction of the optical head 100 with respect to the optical disk 6, and the second sub-beam S2 is converged so as to succeed the main beam M along the scanning direction of the optical head 100 with respect to the optical disk 6, according to the differential push-pull signal output from the DSP 13.

The spindle driving circuit 205 drives the spindle motor 9 based on the rotation direction of the spindle motor 9 set by the rotation direction setting unit 11 and a command value of the number of rotations output from the DSP 13.

As described above, according to Embodiment 1, the first sub-beam S1 is set so as to be converged in a position preceding the position of the main beam M along the scanning direction of the optical head 100 with respect to the optical disk 6, and the second sub-beam S2 is set so as to be converged in a position succeeding the position of the main beam M along the scanning direction of the optical head 100 with respect to the optical disk 6. Further, the diffraction grating 1 divides the light beams into the main beam M, the first sub-beam S1 and the second sub-beam S2 so that the first sub-beam S1 preceding the main beam M is converged on a more outer circumferential side of the optical disk 6 than the main beam M is, and the second sub-beam S2 succeeding the main beam M is converged on a more inner circumferential side of the optical disk 6 than the main beam M is.

According to this configuration, the preceding first sub-beam S1 can be converged so as to bridge between the unrecorded region R6 of the information tracks 7 and another unrecorded region R6 of the information tracks 7 arranged adjacently to the unrecorded region R6 of the information tracks 7 on the outer circumferential side. Further, the succeeding second sub-beam S2 can be converged so as to bridge between the recorded region R5 of the information tracks 7 and another recorded region R5 of the information tracks 7 arranged adjacently to the recorded region R5 of the information tracks 7 on the inner circumferential side. Thus, the first sub-beam signals detected based on the first sub-beam S1 and the second sub-beam signals detected based on the second sub-beam S2 become well balanced, so that an offset does not occur in the differential push-pull signal generated based on the first sub-beam signal and the second sub-beam signal. As a result, recording/reproduction signals can be improved in quality.

Because of variation in light quantity distributions of the first sub-beam S1 and the second sub-beam S2 at a boundary between the recorded region R5 and the unrecorded region R6, the first sub-beam signals C and D that are detected based on the first sub-beam S1 and the second sub-beam signals E and F that are detected based on the second sub-beam S2 become unbalanced. This has led to a conventional problem of the occurrence of an error in a result of the operation using the above-mentioned (Equation 1) that results in a beam spot shift from a track center.

In Embodiment 1, the first sub-beam S1 overlaps the unrecorded region R6 on both of the inner and outer circumferential sides thereof. Accordingly, in an operation of (C−D) in (Equation 1), the variation in the quantity of reflected light at a boundary between the recorded region R5 and the unrecorded region R6 is cancelled. The second sub-beam S2 overlaps the recorded region R5 on both of the inner and outer circumferential sides thereof. Accordingly, in an operation of (E−F) in (Equation 1), the variation in the quantity of reflected light at the boundary between the recorded region R5 and the unrecorded region R6 is cancelled. Thus, an offset of a tracking error signal occurring at a boundary between the recorded region R5 and the unrecorded region R6 can be eliminated.

The first sub-beam S1 is converged at a more outer circumferential side of the optical disk 6 than the information track 7 by about ½ of the track pitch of the information tracks 7. The second sub-beam S2 is converged at a more inner circumferential side of the optical disk 6 than the information track 7 by about ½ of the track pitch. When the first sub-beam S1 and the second sub-beam S2 are converged in positions shifted by about ½ of the track pitch of the information tracks 7 as described above, a push-pull signal based on sub-beams expressed by the following (Equation 2) can be maximized in amplitude. The equation represents the push-pull signal based on the sub-beams before being multiplied by the coefficient α.

The more the converging position of the first sub-beam S1 is shifted with respect to a position on the more outer circumferential side than the information track 7 by about ½ of the track pitch, or the more the converging position of the second sub-beam S2 is shifted with respect to a position on the more inner circumferential side of the information track 7 by about ½ of the track pitch, the push-pull signal based on the sub-beams before being multiplied by the coefficient α, which is expressed by the following (Equation 2), is decreased in amplitude:

(C−D)+(E−F) (Equation 2).

When the push-pull signal based on the sub-beams before being multiplied by the coefficient α is decreased in amplitude as described above, the influence of disturbance due to a flaw on a surface of the optical disk 6 or the like is increased.

Embodiment 1 was described by way of an example, in which information was recorded starting from the inner circumferential side toward the outer circumferential side on the information tracks 7 formed spirally on the optical disk 6. However, the present invention is not limited thereto. On the information tracks 7 formed spirally on the optical disk 6, information may be recorded from the outer circumferential side toward the inner circumferential side. In this case, the rotation direction of the spindle motor that drives the optical disk 6 to rotate should be reversed.

(Embodiment 2)

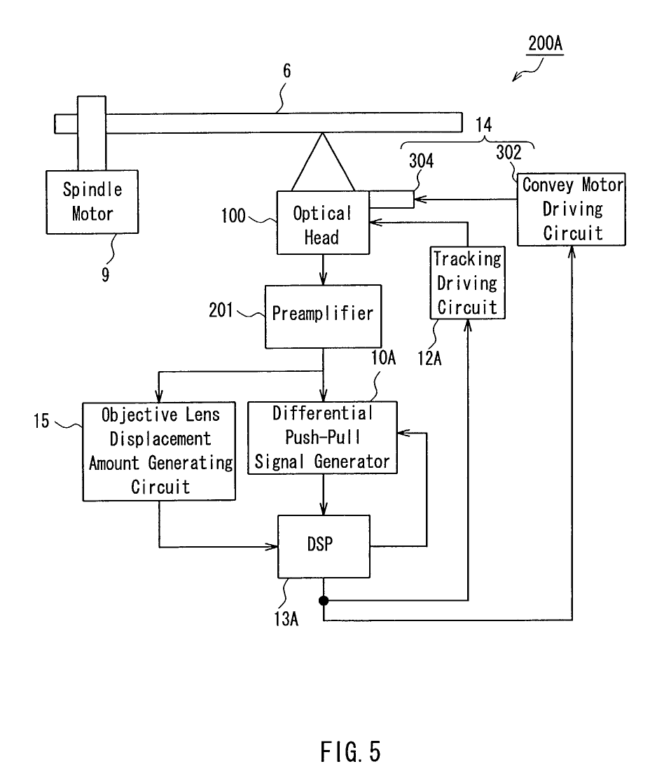

FIG. 5 is a block diagram showing a configuration of an optical disk apparatus 200A according to Embodiment 2. In the figure, like reference numerals indicate like constituent components of the optical disk apparatus 200 described with reference to FIGS. 1 to 4 in Embodiment 1, for which duplicate descriptions are omitted. Unlike the above-described optical disk apparatus 200, the optical disk apparatus 200A includes a differential push-pull signal generator 10A in place of the differential push-pull signal generator 10, DSP 13A in place of the DSP 13, and a tracking driving circuit 12A in place of the tracking driving circuit 12, and further includes objective lens displacement amount generating circuit 15 and a conveying unit 14.

The differential push-pull signal generator 10A is formed of an operational amplifier and generates a main beam push-pull signal MPP based on a main beam signal A and a main beam signal B that have been amplified by a preamplifier 201 according to the following (Equation 3):

MPP=(A−B) (Equation 3).

The differential push-pull signal generator 10A also generates a sub-beam push-pull signal SPP based on a first sub-beam signal C, a first sub-beam signal D, a second sub-beam signal E and a second sub-beam signal F that have been amplified by the preamplifier 201 according to the following (Equation 4):

SPP=α×((C+E)−(D+F)) (Equation 4),

where a coefficient α is a predetermined constant.

The differential push-pull signal generator 10A further generates a correction differential push-pull signal CDPP based on the main beam signal A, the main beam signal B, the first sub-beam signal C, the first sub-beam signal D, the second sub-beam signal E, the second sub-beam signal F and a predetermined correction coefficient β according to the following (Equation 5):

CDPP=(A−B)−α×((1+β)×(C+E))−(1−β)×(D+F)) (Equation 5).

A correction differential push-pull signal CDPP obtained when the correction coefficient β is zero is defined as a differential push-pull signal before being corrected. This uncorrected differential push-pull signal is identical to the differential push-pull signal generated by the differential push-pull signal generator 10 described with regard to Embodiment 1.

The DSP 13A adjusts the predetermined correction coefficient β used for generating the correction differential push-pull signal CDPP by the differential push-pull signal generator 10A so that zero-crossing timing of the sub-beam push pull signal SPP generated by the differential push-pull signal generator 10A coincides with zero-crossing timing of the main beam push-pull signal MPP.

The conveying unit 14 includes a convey motor driving circuit 302. The convey motor driving circuit 302 performs current amplification with respect to the correction differential push-pull signal CDPP that the differential push-pull signal generator 10A generates according to the correction coefficient β adjusted by the DSP 13A, and outputs a signal for conveying an optical head 100 along a radial direction of an optical disk 6 on which information tracks 7 are formed to a convey motor 304. The convey motor 304 conveys the optical head 100 along the radial direction of the optical disk 6 on which the information tracks 7 are formed based on the signal output from the convey motor driving circuit 302.

The tracking driving circuit 12A is provided so that an objective lens 2 provided in the optical head 100 is driven by a tracking actuator that is not shown along the radial direction of the optical disk 6 on which the information tracks 7 are formed, based on the correction differential push-pull signal CDPP that the differential push-pull signal generator 10A generates according to the correction coefficient β adjusted by the DSP 13A.

The DSP 13A converts the correction differential push-pull signal to a digital value and processes it by using a core processor housed in the DSP 13A. The processing by the core processor housed in the DSP 13A is performed so that phase compensation and gain compensation to stabilize a tracking control system can be performed, and is realized by a digital filter. A low-frequency component of the corrected differential push-pull signal CDPP processed by the core processor is converted back to an analog signal by a DA converter housed in the DSP 13A so as to be supplied to the convey motor driving circuit 302. Accordingly, the conveying unit 14 responds to the low-frequency component of the correction differential push-pull signal CDPP, and the objective lens 2 provided in the optical head 100 responds to a high-frequency component of the corrected differential push-pull signal CDPP. Thus, tracking control is performed so that the main beam M radiated from the optical head 100 follows the information tracks 7.

The DSP 13A also has a function of bringing the tracking control to a non-operational state. The DSP 13A also has a function of outputting a predetermined value to the tracking driving circuit 12A where the tracking control is in the non-operational state so that the objective lens 2 provided in the optical head 100 can be displaced.

The objective lens displacement amount generating circuit 15 generates an objective lens displacement signal indicating a displacement amount of the objective lens 2 of the optical head 100, which is driven by the tracking driving circuit 12A, and outputs it to the DSP 13A.

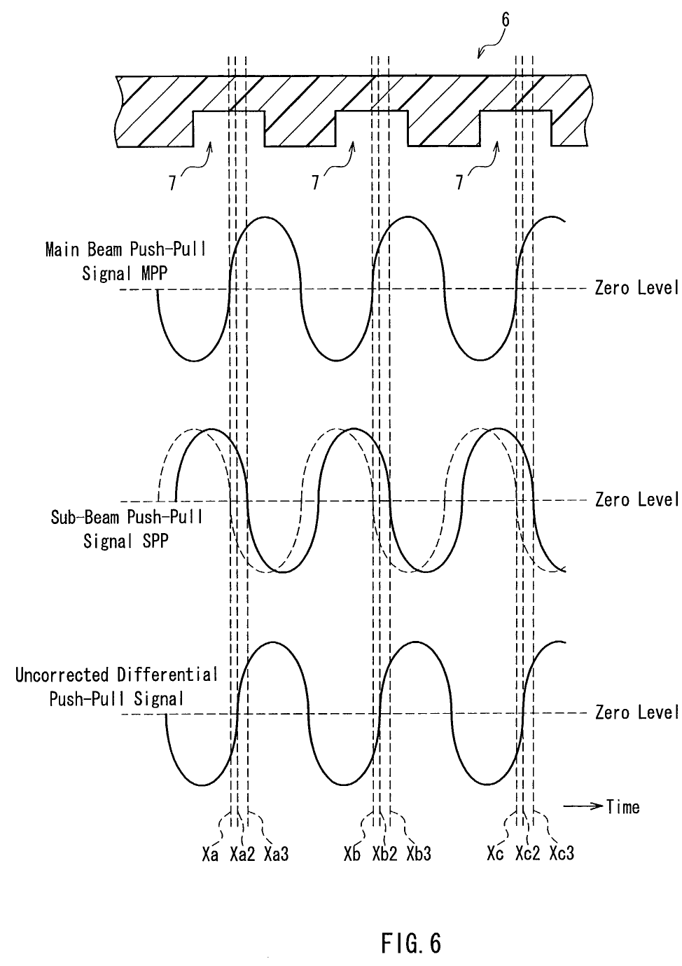

FIG. 6 shows the main beam push-pull signal MPP, the sub-beam push-pull signal SPP and the uncorrected differential push-pull signal for explaining an operation of the optical disk apparatus 200A according to Embodiment 2. A horizontal axis indicates a position on the information tracks 7 along the radial direction of the optical disk 6.

In the figure, a cross section of the optical disk 6 on which the information tracks 7 are formed spirally is shown so as to correspond to the respective waveforms of the main beam push-pull signal MPP, the sub-beam push-pull signal SPP and the uncorrected differential push-pull signal. Each of positions Xa, Xb and Xc indicates a position of a center line of each of the information tracks 7 along the radial direction of the optical disk 6.

The respective waveforms indicates waveforms obtained when the tracking control is in the non-operational state. Accordingly, an amount of displacement of the objective lens 2 with respect to a neutral position of the objective lens 2 along the radial direction of the optical disk 6 has a value of zero. In this configuration, when the objective lens 2 is in the neutral position, an optical axis of the objective lens 2 is set so as to coincide with an optical axis of an incident light beam.

As described earlier, when coma aberration is caused in a beam spot resulting from converging of a sub-beam, a zero-crossing position of the sub-beam push-pull signal SPP shifts from the center line of each of the information tracks 7. Similarly, a zero-crossing position of the main beam push-pull signal MPP shifts from the center line of each of the information tracks 7.

However, a shift amount of the main beam push-pull signal is substantially zero and thus is negligible in signal recording and reproduction. Thus, in the description of Embodiment 2, a shift amount of the main beam push-pull signal MPP is assumed to be zero.

The main beam push-pull signal MPP zero-crosses in the positions Xa, Xb and Xc, each indicating a position of the center line of each of the information tracks 7 along the radial direction of the optical disk 6.

When an error is caused in the mounting of a photodetector 3 provided in the optical head 100, the zero-crossing position of the main beam push-pull signal MPP shifts from the center line of each of the information tracks 7. In the following description, it is assumed that there is no mounting error of the photodetector 3.

As in the case of the main beam push-pull signal MPP, the sub-beam push-pull signal SPP shown by a dotted line zero-crosses in the positions Xa, Xb and Xc, each indicating a position of the center line of each of the information tracks 7.

When coma aberration is caused in a beam spot resulting from converging of the sub-beam push-pull signal SPP, as shown by a solid line, the sub-beam push-pull signal SPP zero-crosses in positions Xa3, Xb3 and Xc3, each shifted from the center line of each of the information tracks 7.

As described above, when coma aberration is caused in a beam spot, even where the main beam M is converged on the center of each of the information tracks 7, the sub-beam push-pull signal SPP does not attain a zero level. The sub-beam push-pull signal SPP zero-crosses in positions Xa3, Xb3 and Xc3, each shifted from the center line of each of the information tracks 7.

The main beam push-pull signal MPP and the sub-beam push-pull signal SPP zero-cross in the vicinity of the center line of each of the information tracks 7, and also in the vicinity of a midpoint between the adjacent information tracks 7. It can be determined whether zero-crossing occurs in the center line of each of the information tracks or at the midpoint between the adjacent information tracks 7, depending on a quantity level of light reflected from a surface of the optical disk 6.

In this specification, a “zero-crossing position” indicates a position in which zero-crossing occurs in the vicinity of the center line of each of the information tracks 7, except where specifically noted.

As described above, the main beam push-pull signal MPP zero-crosses in the positions Xa, Xb and Xc, each indicating the position of the center line of each of the information tracks 7, and the sub-beam push-pull signal SPP zero-crosses in the positions Xa3, Xb3 and Xc3, each shifted from the center line of each of the information tracks 7. Accordingly, as shown in FIG. 6, the uncorrected differential push-pull signal zero-crosses in a position Xa2 between the positions Xa and Xa3, a position Xb2 between the positions Xb and Xb3, and a position Xc2 between the positions Xc and Xc3.

Thus, when tracking control is performed so that the uncorrected differential push-pull signal zero-crosses in the positions Xa, Xb and Xc, each indicating a position of the center line of each of the information tracks 7, the main beam M forms a beam spot in a position shifted from the center line of each of the information tracks 7.

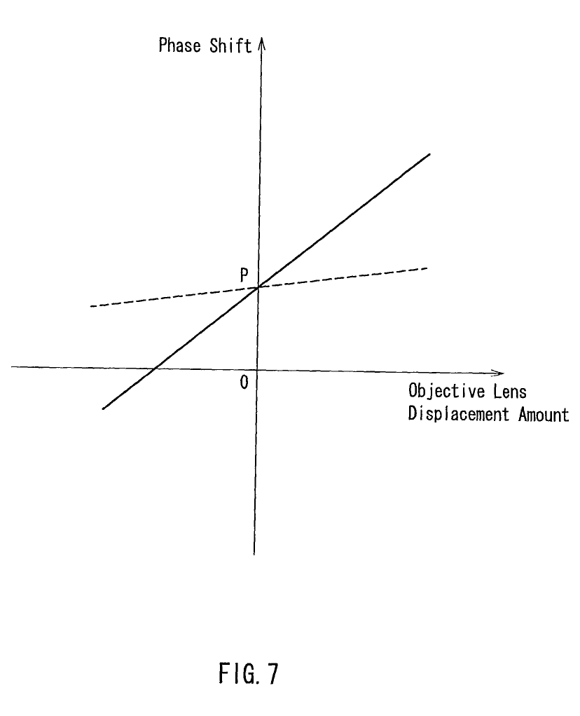

FIG. 7 is a graph showing a relationship between a displacement amount of the objective lens and a phase shift in the optical disk apparatus 200A according to Embodiment 2. A horizontal axis indicates a displacement amount of the objective lens, and a vertical axis indicates a phase shift. As shown in FIG. 7, when the displacement amount of the objective lens has a value of zero, a predetermined phase shift P is caused.

The following description is directed to an operation in which the DSP 13A corrects an amount of a shift between a zero-crossing position of the sub-beam push-pull signal SPP and the center line of each of the information tracks 7 by adjusting the correction coefficient β.

Where tracking control is in a non-operational state, the DSP 13A measures an amount of a shift between zero-crossing timing of the main beam push-pull signal MPP at the center line of each of the information tracks 7 and zero-crossing timing of the sub-beam push-pull signal SPP. Then, the DSP 13A adjusts the above-described correction coefficient β so that the zero-crossing timing of the sub-beam push-pull signal SPP coincides with the zero-crossing timing of the main beam push-pull signal MPP. Next, the DSP 13A stores a value of the adjusted correction coefficient β in a predetermined memory. Further, in that state, the DSP 13A stores a value of a displacement amount of the objective lens output from the objective lens displacement amount generating circuit 15 in a predetermined memory.

The processing in which the correction coefficient β is adjusted so that the zero-crossing timing of the sub-beam push-pull signal SPP coincides with the zero-crossing timing of the main beam push-pull signal MPP can be realized easily in the following manner. That is, in the processing, the DSP 13A processes the main beam push-pull signal MPP and the sub-beam push-pull signal SPP that are output from the differential push-pull signal generator 10A by converting them to digital values.

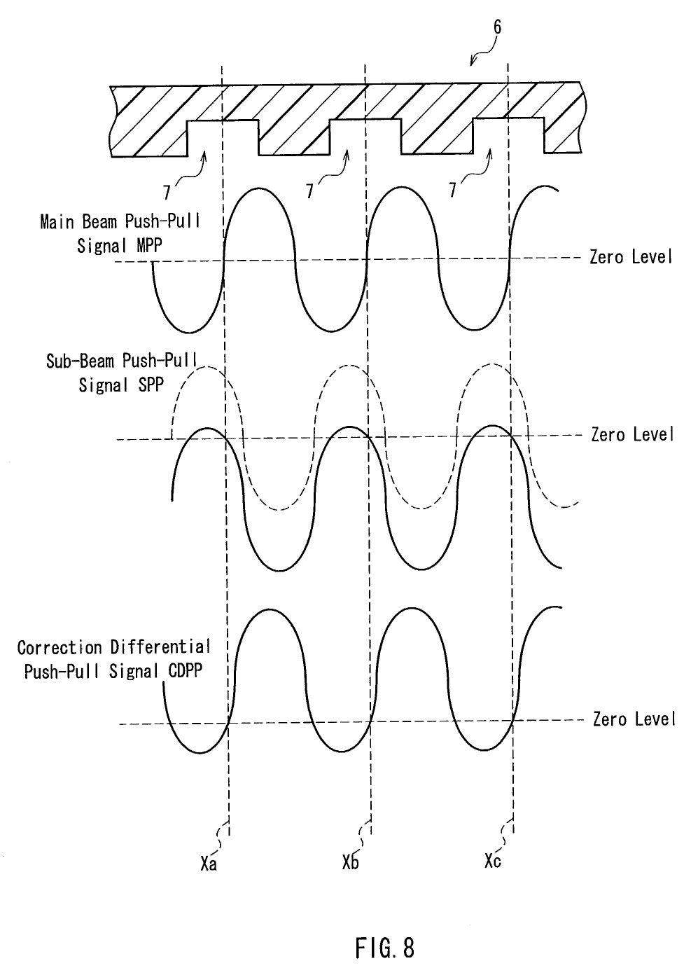

FIG. 8 is a diagram showing the main beam push-pull signal MPP, the sub-beam push-pull signal SPP and the correction differential push-pull signal CDPP for explaining the operation of the optical disk apparatus 200A according to Embodiment 2. As described with regard to FIG. 6, a horizontal axis indicates a position on the information tracks 7 along the radial direction of the optical disk 6. In the figure, a cross section of the optical disk 6 on which the information tracks 7 are formed spirally is shown so as to correspond to the respective waveforms of the main beam push-pull signal MPP, the sub-beam push-pull signal SPP and the correction differential push-pull signal CDPP. Each of positions Xa, Xb and Xc indicates a position of the center line of each of the information tracks 7 along the radial direction of the optical disk 6.

The main beam push-pull signal MPP zero-crosses in the positions Xa, Xb and Xc, each indicating a position of the center line of each of the information tracks 7 along the radial direction of the optical disk 6.

The sub-beam push-pull signal SPP shown by a dotted line indicates the sub-beam push-pull signal obtained when the correction coefficient β is zero. The sub-beam push-pull signal SPP shown by a solid line indicates the sub-beam push-pull signal obtained when the correction coefficient β is set to be an optimum value. The sub-beam push-pull signal SPP shown by a solid line zero-crosses in the positions Xa, Xb and Xc, each indicating the position of the center line of each of the information tracks 7. As described above, zero-crossing timing of the sub-beam push-pull signal SPP with the correction coefficient β set to be an optimum value, which is shown by the solid line, coincides with zero-crossing timing of the main beam push-pull signal MPP. The correction differential push-pull signal CDPP generated based on the optimum correction coefficient β zero-crosses in the positions Xa, Xb and Xc, each indicating the position of the center line of each of the information tracks 7.

As describe above, according to Embodiment 2, the predetermined correction coefficient β used for generating the correction differential push-pull signal CDPP by the differential push-pull signal generator 10A is adjusted so that the zero-crossing timing of the sub-beam push-pull signal SPP generated by the differential push-pull signal generator 10A coincides with the zero-crossing timing of the main beam push-pull signal MPP.

According to this configuration, the zero-crossing timing of the sub-beam push-pull signal SPP is allowed to coincide with the zero-crossing timing of the main beam push-pull signal MPP. Thus, the zero-crossing timing of the sub-beam push-pull signal SPP coincides with the timing corresponding to the center line of each of the information tracks 7. As a result, excellent tracking control without the occurrence of a beam spot shift from a track center can be realized.

As described earlier, when there is an error in mounting of the photodetector 3, the zero-crossing position of the main beam push-pull signal MPP shifts from the center line of the information track 7. As a result, in this case where there is an error in the mounting of the photodetector 3, the main beam forms a beam spot in a position shifted from the center line of the information track 7 when the correction coefficient β is adjusted so that the zero-crossing timing of the sub-beam push-pull signal SPP coincides with the zero-crossing timing of the main beam push-pull signal MPP.

However, even when there is an error in mounting of the photodetector 3, timing where the main beam push-pull signal MPP attains a central amplitude level of the main beam push-pull signal MPP coincides with timing corresponding to the center line of the information track 7.

Thus, when there is an error in the mounting of the photodetector 3, the correction coefficient β should be adjusted so that the main beam push-pull signal MPP becomes equal to the sub-beam push-pull signal SPP in level at a time when the main beam push-pull signal MPP attains the central amplitude level for the main beam push-pull signal MPP.

The description is directed next to another operation of the optical disk apparatus 200 according to Embodiment 2.

Where tracking control is in the non-operational state, the DSP 13A outputs a predetermined value to the tracking driving circuit 12A so that the objective lens 2 provided in the optical head 100 can be displaced. Then, the DSP 13A measures an amount of a shift between the zero-crossing timing of the main beam push-pull signal MPP at the center line of each of the information tracks 7 and the zero-crossing timing of the sub-beam push pull signal SPP. After that, the DSP 13A adjusts the above-mentioned correction coefficient β so that the zero-crossing timing of the sub-beam push-pull signal SPP coincides with the zero-crossing timing of the main beam push-pull signal MPP.

Next, the DSP 13A stores a value of the adjusted correction coefficient β in a predetermined memory. The value of the adjusted correction coefficient β allows the correction coefficient β to be optimum, where a predetermined value is output to the tracking driving circuit 12A so that the objective lens 2 is displaced. That is, by using the value, the zero-crossing position of the correction differential push-pull signal CDPP coincides with the center line of each of the information tracks 7.

The description is directed next to an operation of the objective lens displacement amount generating circuit 15. The objective lens displacement amount generating circuit 15 is formed of an operational amplifier. The objective lens displacement amount generating circuit 15 generates an objective lens displacement signal LS indicating a displacement amount of the objective lens 2 of the optical head 100 driven by the tracking driving circuit 12A, based on the main beam signals A and B, the first sub-beam signals C and D, and the second sub-beam signals E and F according to the following (Equation 6), and outputs it to the DSP 13A:

LS=(A−B)+α×((C+E)−(D+F)) (α is a constant) (Equation 6).

The DSP 13A also stores an objective lens displacement amount LS output from the objective lens displacement amount generating circuit 15 in a predetermined memory.

Next, while varying a value to be set with respect to the tracking driving circuit 12A, the DSP 13A sets an optimum value of the correction coefficient β, where the value to be set with respect to the tracking driving circuit 12A is adjusted, measures an output value from the objective lens displacement amount generating circuit 15, and stores the optimum value of the correction coefficient β and the output value from the objective lens displacement amount generating circuit 15 in a predetermined memory. Thus, in the memory provided in the DSP 13A, a table showing a relationship between the output value from the objective lens displacement amount generating circuit 15 and the optimum correction coefficient β is stored. Processing for determining the optimum correction coefficient β is the same as that described above, in which the optimum correction coefficient β was determined without displacing the objective lens 2.

Next, where tracking control is the operational state, the DSP 13A fetches a displacement amount of the objective lens output from the objective lens displacement amount generating circuit 15. Then, the DSP 13A reads out an optimum value of the correction coefficient β corresponding to a displacement amount of the objective lens output from the objective lens displacement amount generating circuit 15 from the above-mentioned table that has been prepared beforehand. After that, the DSP 13A adjusts the correction coefficient β of the differential push-pull signal generating circuit 10A based on the read-out value of the correction coefficient β. Thus, the phase shift shown in FIG. 7, which is ascribable to a shift between zero-crossing of the sub-beam push-pull signal SPP and the center of each of the information tracks 7, can be eliminated.

When dust or the like with a zero reflectance adheres on the surface of the optical disk 6, the correction coefficient β is set so as to be adjusted, and therefore the sub-beam push-pull signal SPP results in a zero level. Thus, tracking control can be prevented from becoming unstable by dust adhering on the surface of the optical disk 6 or the like.

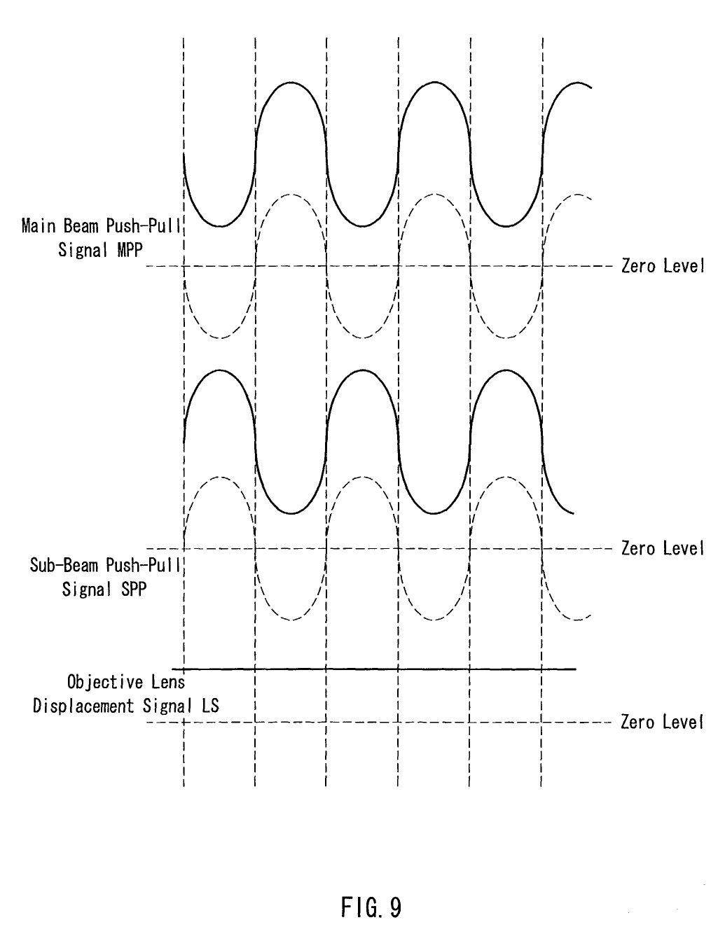

FIG. 9 is a wave form chart for explaining still another operation of the optical disk apparatus 200A according to Embodiment 2. In the following description, it is assumed for simplicity that there is no shift between a zero-crossing position of the sub-beam push-pull signal SPP and the center of each of the information tracks 7.

The main beam push-pull signal MPP shown by a dotted line indicates the main beam push-pull signal obtained when the objective lens 2 is in a neutral position, and the main beam push-pull signal MPP shown by a solid line indicates the main beam push-pull signal obtained when the objective lens 2 is displaced by a predetermined amount.

Similarly, the sub-beam push-pull signal SPP shown by a dotted line indicates the sub-beam push-pull signal obtained when the objective lens 2 is in the neutral position, and the sub-beam push-pull signal SPP shown by a solid line indicates the sub-beam push-pull signal obtained when the objective lens 2 is displaced by a predetermined amount. An objective lens displacement signal LS shown by a dotted line indicates the objective lens displacement signal obtained when the objective lens 2 is in the neutral position, and the objective lens displacement signal LS shown by a solid line indicates the objective lens displacement signal obtained when the objective lens 2 is displaced by a predetermined amount.

As shown in FIG. 9, when the objective lens 2 is in the neutral position, a mean value of the maximum value and the minimum value of the main beam push-pull signal MPP is at a zero level, and a mean value of the maximum value and the minimum value of the sub-beam push-pull signal SPP is at a zero level. When the objective lens 2 is in the neutral position, an AC component is shifted in phase by 180 degrees, so that the objective lens displacement signal LS is at a zero level.

As shown in FIG. 9, when the objective lens 2 is displaced by a predetermined amount, a mean value of the maximum value and the minimum value of the main beam push-pull signal MPP is not at a zero level, and a mean value of the maximum value and the minimum value of the sub-beam push-pull signal SPP is also not at a zero level. Further, the main beam push-pull signal MPP and the sub-beam push-pull signal SPP are shifted in phase of the AC component with respect to each other by 180 degrees. Accordingly, in the objective lens displacement signal LS, only a DC component remains, with the AC component cancelled out. A mean value of the maximum value and the minimum value of the main beam push-pull signal MPP and a mean value of the maximum value and the minimum value of the sub-beam push-pull signal SPP vary according to a displacement amount of the objective lens 2. Thus, the objective lens displacement signal LS indicates a displacement amount of the objective lens 2.

When there is a shift between a zero-crossing position of the sub-beam push-pull signal SPP and the center of each of the information tracks 7, while the AC component is not offset completely, the AC component is extremely small compared with variations of the DC component and thus is negligible.

When the phase shift between the zero-crossing position of the sub-beam push-pull signal SPP and the center of each of the information tracks 7 exhibits a property shown by the dotted line in FIG. 7, an amount of the phase shift hardly varies with respect to a displacement amount of the objective lens. Thus, the correction coefficient β may be fixed, regardless of a displacement amount of the objective lens 2, to a value obtained by determining only an optimum value of the correction coefficient β in the case where there is no displacement of the objective lens. This allows the processing performed by the DSP 10A to be simplified.

The foregoing description was directed to an example where the correction coefficient 6 was adjusted so that the zero-crossing timing of the sub-beam push-pull signal SPP coincided with the zero-crossing timing of the main beam push-pull signal MPP. However, the present invention is not limited thereto. Instead of adjusting the correction coefficient β, a target position with respect to which the tracking control is performed may be adjusted. Specifically, the tracking control should be performed based on a signal obtained by adding an offset to the uncorrected differential push-pull signal. In this case, instead of adjusting the correction coefficient β, an offset amount is adjusted.

Furthermore, the same effect can be obtained also by the following method. That is, the correction differential push-pull signal CDPP is generated based on the following (Equation 7), and a correction coefficient β′ is adjusted:

CDPP=(A−B)−α×(β′×(C+E)−(1/β′)×(D+F)) (Equation 7).

The foregoing Embodiment 2 was directed to an example where the DSP 13A measured a shift between the zero-crossing timing of the main beam push-pull signal MPP at the center of each groove and the zero-crossing timing of the sub-beam push-pull signal SPP, and adjusted the correction coefficient β so that the zero-crossing timing of the sub-beam push-pull signal SPP coincided with the zero-crossing timing of the main beam push-pull signal MPP. However, the present invention is not limited thereto. An optimum value of the correction coefficient 6 can be determined also by the following method.

The DSP 13A allows tracking control to be operated. Accordingly, the main beam M is controlled so as to follow the centers of the respective information tracks 7. Then, the DSP 13A allows a light beam to shift to an adjacent groove on an inner side for every rotation of the optical disk 6. In the following description, a period in which a light beam is allowed to shift is referred to as a jumping period. The information tracks 7 are formed spirally on the optical disk 6. Therefore, when a light beam is controlled so as to follow the information tracks 7, the light beam is allowed to move toward an outer circumferential direction by one groove for every rotation of the optical disk 6. Accordingly, when the light beam is allowed to move to an adjacent groove on the inner side for every rotation of the optical disk 6, a beam spot resulting from converging of the light beam is always in a predetermined position of the information tracks 7. Further, the conveying unit 14 is controlled so that the displacement amount of the objective lens 2 becomes zero.

When the light beam is allowed to move to an adjacent groove on the inner side, the tracking control is halted. Then, the objective lens 2 is moved to an inner circumferential side by the tracking driving circuit 12A, and the tracking control is started again after the light beam is moved to an information track on the inner circumferential side.

The DSP 13A measures the respective amplitudes at a positive side and a negative side of the main beam push-pull signal MPP during the jumping period with reference to a level of the main beam push-pull signal MPP during a period other than the jumping period. The amplitude at the positive side is referred to as a positive-side amplitude BV, and the amplitude at the negative side is referred to as a negative-side amplitude SV The DSP 13A adjusts the coefficient β so that the positive-side amplitude BV equals the negative-side amplitude SV.

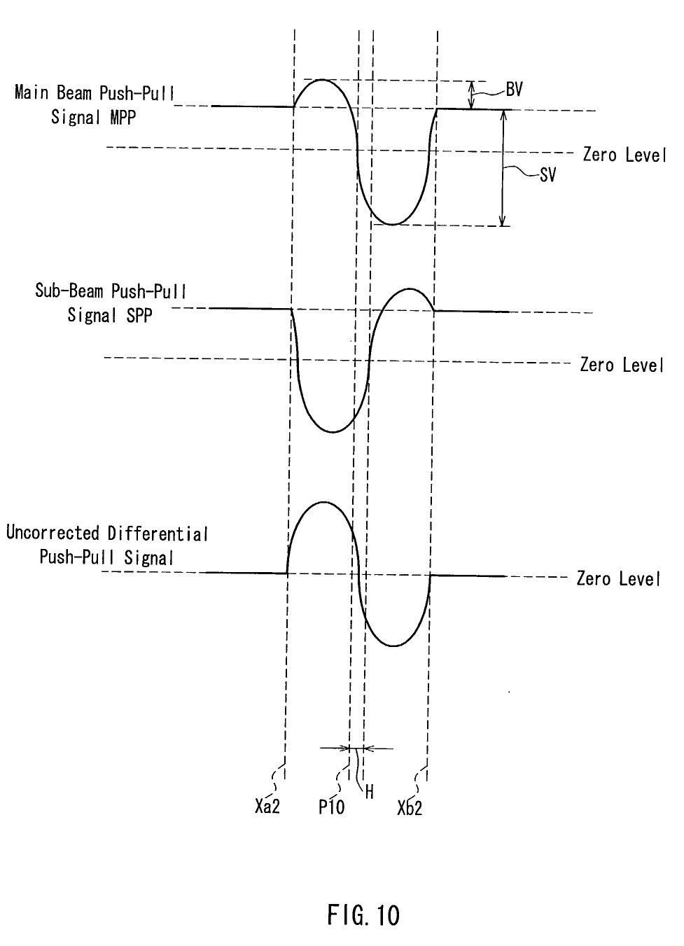

FIG. 10 is a wave form chart showing the main beam push-pull signal MPP, the sub-beam push-pull signal SPP and the correction differential push-pull signal before being corrected for explaining still another operation of the optical disk apparatus 200A according to Embodiment 2.

The main beam push-pull signal MPP zero-crosses at a midpoint P10 between the information tracks 7 adjacent to each other. The sub-beam push-pull signal SPP zero-crosses in a position at a distance H from the midpoint P10. Accordingly, the uncorrected differential push-pull signal zero-crosses in a position shifted from the midpoint P10. The distance H corresponds to the positional shift P shown in FIG. 7.

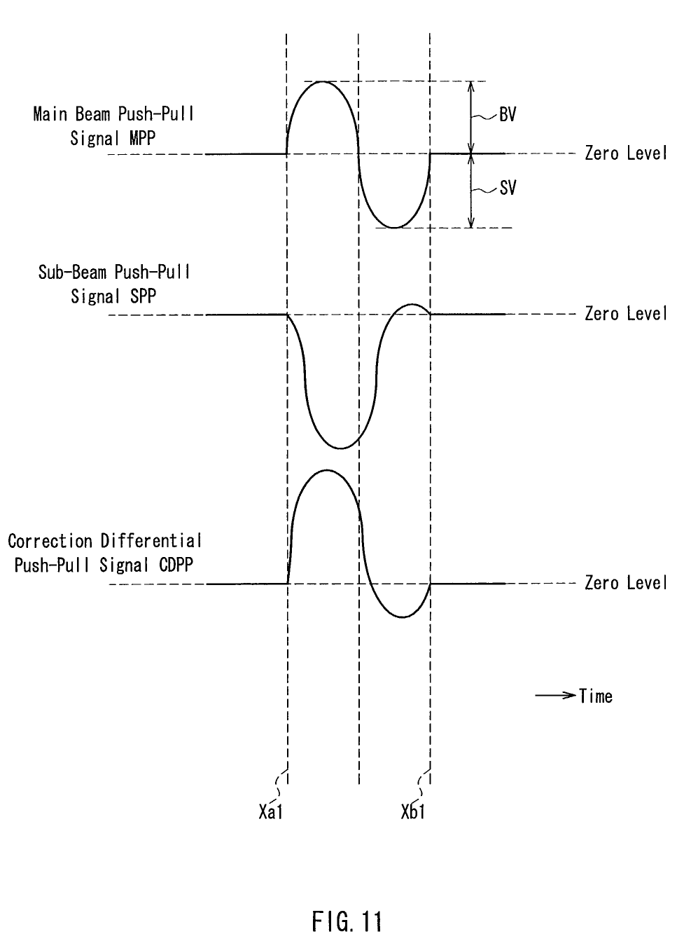

FIG. 11 is a wave form chart showing the main beam push-pull signal MPP, the sub-beam push-pull signal SPP and the correction differential push-pull signal CDPP for explaining still another operation of the optical disk apparatus 200A according to Embodiment 2.

As shown in FIG. 11, the DSP 13A determines, while varying the correction coefficient β, a value of the correction coefficient β that allows the positive-side amplitude BV and the negative-side amplitude SV of the main beam push-pull signal MPP to be equal to each other. When the positive-side amplitude BV and the negative-side amplitude SV of the main beam push-pull signal MPP are equal to each other, the main beam push-pull signal MPP zero-crosses at midpoints of the respective pairs of the adjacent information tracks 7. When the main beam push-pull signal MPP zero-crosses at the midpoints of the respective pairs of the adjacent information tracks 7, zero-crossing of the main beam push-pull signal MPP also occurs at the center line of each of the information tracks 7. Thus, the occurrence of a beam spot shift from a track center is eliminated.

As shown in FIG. 11, a positive-side amplitude and a negative-side amplitude of the corrected differential push-pull signal CDPP become unbalanced. Accordingly, during a predetermined period after tracking control is started, transition to the tracking control is made unstable by overshoot. Thus, in the predetermined period after the tracking control is started, the tracking control should be performed by setting the correction coefficient β to zero. The predetermined period is defined as a period until a tracking control system is settled, and generally is a period of several milliseconds.

As described in the foregoing description, according to the present invention, there can be provided an optical head and an optical disk apparatus that achieve an excellent quality of signals recorded on and/or reproduced from an optical disk.

When the correction coefficient β is set to be an extremely large value, a dynamic range at one side of the correction differential push-pull signal becomes extremely limited. As a result, the tracking control may become unstable by disturbance such as vibration or the like. Thus, there should be provided a limit to a range of values of the correction coefficient β to be adjusted.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical head for radiating light beams onto information tracks formed spirally on a rotatable information medium so that information can be recorded on the information tracks, comprising:
a light source that emits the light beams;
a diffraction grating that diffracts the light beams emitted from the light source so that the light beams are divided into a main beam, a first sub-beam and a second sub-beam;
an objective lens for converging the main beam, the first sub-beam and the second sub-beam resulting from diffraction by the diffraction grating, respectively, on the information tracks formed on the information medium; and
a photodetector that detects a main beam signal, a first sub-beam signal and a second sub-beam signal, respectively, based on the main beam, the first sub-beam and the second sub-beam that have been reflected respectively from the information tracks formed on the information medium,
wherein the first sub-beam is set so as to be converged in a position preceding a position of the main beam along a scanning direction of the optical head with respect to the information medium, and the second sub-beam is set so as to be converged in a position succeeding the position of the main beam along the scanning direction of the optical head with respect to the information medium; and
the diffraction grating divides the light beams into the main beam, the first sub-beam and the second sub-beam so that the first sub-beam preceding the main beam is converged at a more outer circumferential side of the information medium than the main beam is, and the second sub-beam succeeding the main beam is converged at a more inner circumferential side of the information medium than the main beam is.

2. The optical head according to claim 1,
wherein the diffraction grating divides the light beams into the main beam, the first sub-beam and the second sub-beam so that the first sub-beam is converged at a more outer circumferential side of the information medium than the information track by about ½ of a track pitch of the spirally formed information tracks, and the second sub-beam is converged at a more inner circumferential side of the information medium than the information track by about ½ of the track pitch.

3. The optical head according to claim 1,
wherein the first sub-beam is converged so as to bridge between a first region of the information tracks and a second region of the information tracks arranged adjacently to the first region of the information tracks on an outer circumferential side, and the second sub-beam is converged so as to bridge between a third region of the information tracks and a fourth region of the information tracks arranged adjacently to the third region of the information tracks on an inner circumferential side.

4. The optical head according to claim 1,
wherein the information tracks are made up of grooves formed on a surface of the information medium.

5. The optical head according to claim 1,
wherein, on the information tracks formed spirally on the information medium, the information is recorded starting from an inner circumferential side toward an outer circumferential side.

6. The optical head according to claim 1,
wherein, on the information tracks formed spirally on the information medium, a recorded region on which the information has been prerecorded is arranged on an inner circumferential side of the information tracks, and an unrecorded region on which the information has not been recorded yet is arranged on an outer circumferential side of the information tracks.

7. The optical head according to claim 6,
wherein the optical head starts radiation of the main beam, the first sub-beam and the second sub-beam onto the information tracks from a boundary between the recorded region and the unrecorded region arranged on the information tracks.

8. The optical head according to claim 1,
wherein the main beam is a 0th-order diffracted light beam that originates in the light beams;
the first sub-beam is one of a +1st-order diffracted light beam and a −1st-order diffracted light beam that originate in the light beams; and
the second sub-beam is the other of the +1st-order diffracted light beam and the −1st-order diffracted light beam that originate in the light beams.

9. The optical head according to claim 1, further comprising a beam splitter provided between the diffraction grating and the objective lens so that the main beam, the first sub-beam and the second sub-beam that have been reflected from the information tracks can be led to the photodetector.

10. An optical disk apparatus, comprising:
an optical head as claimed in claim 1;
a motor for rotating the information medium;
a differential push-pull signal generator that generates a differential push-pull signal based on the main beam signal, the first sub-beam signal and the second sub-beam signal that have been detected by the photodetector provided in the optical head; and
a rotation direction setting unit that sets a rotation direction of the motor so that the first sub-beam is converged so as to precede the main beam along the scanning direction of the optical head with respect to the information medium, and the second sub-beam is converged so as to succeed the main beam along the scanning direction of the optical head with respect to the information medium, according to the differential push-pull signal generated by the differential push-pull signal generator.

11. The optical disk apparatus according to claim 10, further comprising a tracking driving circuit that drives the optical head along a radial direction of the information medium so that the main beam radiated from the optical head follows the information tracks, based on the differential push-pull signal generated by the differential push-pull signal generator.

12. An optical disk apparatus, comprising:
an optical head for radiating light beams onto information tracks so that information can be recorded on and/or reproduced from the information tracks, comprising:
a light source that emits the light beams;
a diffraction grating that diffracts the light beams emitted from the light source so that the light beams are divided into a main beam, a first sub-beam and a second sub-beam;
an objective lens for converging the main beam, the first sub-beam and the second sub-beam resulting from diffraction by the diffraction grating, respectively, on the information tracks formed on the information medium; and
a photodetector that detects a main beam signal, a first sub-beam signal and a second sub-beam signal, respectively, based on the main beam, the first sub-beam and the second sub-beam that have been reflected respectively from the information tracks formed on the information medium;
a differential push-pull signal generator that generates a main beam push-pull signal based on the main beam signal detected by the photodetector provided in the optical head, generates a sub-beam push-pull signal based on the first and second sub-beam signals detected by the photodetector, and generates a correction differential push-pull signal based on the main beam signal, the first and second sub-beam signals and a predetermined correction coefficient β; and
a correction coefficient adjusting unit that adjusts the predetermined correction coefficient β used for generating the correction differential push-pull signal by the differential push-pull signal generator so that the main beam push-pull signal generated by the differential push-pull signal generator becomes equal to the sub-beam push-pull signal in level at a time when the main beam push-pull signal attains a central amplitude level for the main beam push-pull signal.

13. The optical disk apparatus according to claim 12, wherein the photodetector includes:
a main beam detecting unit that detects the main beam signal based on the main beam;
a first sub-beam detecting unit that detects the first sub-beam signal based on the first sub-beam; and
a second sub-beam detecting unit that detects the second sub-beam signal based on the second sub-beam.

14. The optical disk apparatus according to claim 13,
wherein each of the main beam detecting unit, the first sub-beam detecting unit and the second sub-beam detecting unit is divided into two regions along a direction corresponding to a circumferential direction of the spirally formed information tracks.

15. The optical disk apparatus according to claim 12, further comprising a conveying unit that conveys the optical head along a radial direction of the information medium on which the information tracks are formed, based on the correction differential push-pull signal that the differential push-pull signal generator generates according to the correction coefficient β adjusted by the correction coefficient adjusting unit.

16. The optical disk apparatus according to claim 12, further comprising a tracking driving circuit that drives the objective lens provided in the optical head along a radial direction of the information medium on which the information tracks are formed, based on the correction differential push-pull signal that the differential push-pull signal generator generates according to the correction coefficient β adjusted by the correction coefficient adjusting unit.

17. The optical disk apparatus according to claim 16, further comprising an objective lens displacement signal generating circuit that generates an objective lens displacement signal indicating a displacement amount of the objective lens driven by the tracking driving circuit, based on the main beam signal, the first sub-beam signal and the second sub-beam signal that have been detected by the photodetector.

18. The optical disk apparatus according to claim 17,
wherein the correction coefficient adjusting unit stores in a predetermined memory the objective lens displacement signal generated by the objective lens displacement signal generating circuit and the predetermined correction coefficient β adjusted so that the main beam push-pull signal becomes equal to the sub-beam push-pull signal in level at a time when the main beam push-pull signal attains a central amplitude level for the main beam push-pull signal, while varying a set value to be set for the tracking driving circuit where tracking control by the tracking driving circuit is in a non-operational state.

19. An optical disk apparatus, comprising:
an optical head for radiating light beams onto information tracks so that information can be recorded on and/or reproduced from the information tracks, comprising:
a light source that emits the light beams;
a diffraction grating that diffracts the light beams emitted from the light source so that the light beams are divided into a main beam, a first sub-beam and a second sub-beam;
an objective lens for converging the main beam, the first sub-beam and the second sub-beam resulting from diffraction by the diffraction grating, respectively, on the information tracks formed on an information medium; and
a photodetector that detects a main beam signal, a first sub-beam signal and a second sub-beam signal, respectively, based on the main beam, the first sub-beam and the second sub-beam that have been reflected respectively from the information tracks formed on the information medium;
a differential push-pull signal generator that generates a main beam push-pull signal based on the main beam signal detected by the photodetector provided in the optical head, generates a sub-beam push-pull signal based on the first and second sub-beam signals detected by the photodetector, and generates a correction differential push-pull signal based on the main beam signal, the first and second sub-beam signals and a predetermined correction coefficient β;
a tracking driving circuit provided so as to drive the objective lens provided in the optical head along a radial direction of the information medium on which the information tracks are formed, based on the correction differential push-pull signal; and
a correction coefficient adjusting unit that adjusts the predetermined correction coefficient β used for generating the correction differential push-pull signal by the differential push-pull signal generator so that a level of the main beam push-pull signal in a state where tracking control is operated substantially corresponds with a central amplitude level for the main beam push-pull signal in a state where the tracking control is not operated.

20. The optical disk apparatus according to claim 19,
wherein the correction coefficient adjusting unit measures a maximum amplitude BV at a positive side of the main beam push-pull signal and a maximum amplitude SV at a negative side of the main beam push-pull signal with reference to a level of the main beam push-pull signal in the state where the tracking control is operated during a period in which the tracking driving circuit drives the objective lens toward one of an outer circumferential side and an inner circumferential side so that a beam spot of the main beam radiated from the optical head onto the information medium moves to an adjacent information track on the one of the outer circumferential side and the inner circumferential side, and adjusts the predetermined correction coefficient β so that the maximum amplitude BV at the positive side is substantially equal to the maximum amplitude SV at the negative side.

21. The optical disk apparatus according to claim 19,
wherein the tracking driving circuit performs the tracking control by setting the correction coefficient β to be substantially zero during a predetermined period after starting the tracking control.

22. The optical disk apparatus according to claim 19, wherein the correction coefficient adjusting unit limits a range of values of the correction coefficient β to be adjusted.

23. An optical disk apparatus, comprising:
an optical head for radiating light beams onto information tracks so that information can be recorded on and/or reproduced from the information tracks, comprising:
a light source that emits the light beams;
a diffraction grating that diffracts the light beams emitted from the light source so that the light beams are divided into a main beam, a first sub-beam and a second sub-beam;
an objective lens for converging the main beam, the first sub-beam and the second sub-beam resulting from diffraction by the diffraction grating, respectively, on the information tracks formed on the information medium; and
a photodetector that detects a main beam signal, a first sub-beam signal and a second sub-beam signal, respectively, based on the main beam, the first sub-beam and the second sub-beam that have been reflected respectively from the information tracks formed on the information medium;
a differential push-pull signal generator that generates a main beam push-pull signal based on the main beam signal detected by the photodetector provided in the optical head, generates a sub-beam push-pull signal based on the first and second sub-beam signals detected by the photodetector, and generates an offset differential push-pull signal based on the main beam signal, the first and second sub-beam signals and a predetermined offset amount; and
an offset amount adjusting unit that adjusts the predetermined offset amount used for generating the offset differential push-pull signal by the differential push-pull signal generator so that the main beam push-pull signal generated by the differential push-pull signal generator becomes equal to the sub-beam push-pull signal in level at a time when the main beam push-pull signal attains a central amplitude level for the main beam push-pull signal.
